(19) United States
(12) Patent Application Publication
(10) Pub. No.: US 2017/0027159 A1
(43) Pub. Date: Feb. 2, 2017

(54) Dual Anchor Climbing Tree Stand

(71) Applicant: Michael R. Johnson, Powder Springs, GA (US)

(72) Inventor: Michael R. Johnson, Powder Springs, GA (US)

(21) Appl. No.: 15/225,804

(22) Filed: Aug. 1, 2016

Related U.S. Application Data
(60) Provisional application No. 62/199,222, filed on Jul. 30, 2015.
(60) Provisional application No. 62/275,769, filed on Jan. 6, 2016.
(60) Provisional application No. 62/276,216, filed on Jan. 7, 2016.
(60) Provisional application No. 62/286,431, filed on Jan. 24, 2016.

(51) Int. Cl. A01M 31/02

(52) U.S. Cl. CPC A01M 31/02

(57) ABSTRACT

A dual platform dual anchor climbing tree stand includes a first platform and a second platform, each platform including a frame section with a hexagonal tube structure and dual anchors, the dual anchors providing a plurality of contact points for securing the climbing tree stand, the first platform further including an adjustable seat and lumbar back support, the second platform further including foot straps, and both platforms including a cable assembly for attaching each platform to a tree.

### BACKGROUND

This invention pertains to tree stands. More particularly, this invention pertains to a climbing tree stand having an upper or seat platform that includes an adjustable and removable seat, a lumbar back support for the seat, and a lower or foot platform that includes dual anchor architecture in each platform, and a triangle cable assembly extending from the hexagonal architecture frame of each platform section.

### BRIEF SUMMARY

According to one embodiment of the present invention, a dual platform climbing tree stand is provided. The dual platform climbing tree stand includes an upper platform having an adjustable and removable seat, a lumbar back support for the seat in the upper platform, a lower platform, improved tree anchor architecture in each platform, and a triangle cable assembly extending from each hexagon frame section at the base of the upper platform and at the base of the lower platform. Functionality of the triangle cable assembly is deemed to be the same for both the upper platform and the lower platform.

In one embodiment, a dual platform climbing tree stand includes a first platform further including a first frame section having a first hexagon profile, the hexagon profile including a plurality of hexagonal shaped tubes interconnected to form the first frame, the first frame further including a first dual anchor, the first dual anchor including a plurality of rows of teeth, each row of teeth extending rearward from the first frame in a different direction, an adjustable seat attached to the first frame, a lumbar back support attached to the first frame, a first cable assembly attachable to the first frame for securing the first platform to a tree, a second platform having a second frame section, the second frame section further including a second frame section having a second hexagon profile, the hexagon profile having a plurality of hexagonal shaped tubes interconnected to form the second frame, a first cable assembly attachable to the first frame for securing the first platform to a tree, whereby first platform and the second platform are operable together for climbing a tree and securing the first platform to the tree, and securing the second platform separately to the tree.

In another embodiment, each row of teeth of the first dual anchor extending rearward at an angle from a rear hexagonal tube of the first frame, and each row of teeth of the second dual anchor extending rearward at an angle from a rear hexagonal tube of the second frame.

In another embodiment, the first dual anchor includes at least two pair of rows of teeth, wherein each pair of rows of teeth extend at corresponding and different directions from each other relative to the rear hexagonal tube of the first frame.

In another embodiment, the second dual anchor includes at least two pair of rows of teeth, wherein each pair of rows of teeth extend at corresponding and different directions each other relative to the rear hexagonal tube of the second frame.

In another embodiment, the first cable assembly extends from a first side hexagonal tube and removably fastenable to a second side hexagonal tube, wherein the first side hexagonal tube and the second side hexagonal tube are parallel and opposite each other extending lengthwise along the first platform

In another embodiment, the first frame includes a plurality of crossing hexagonal tube structures extending between opposing sides of the first frame, and a plurality of lengthwise hexagonal tube structures extending from a rear hexagonal tube toward the front of the first frame section.

In another embodiment, a grid section is attached atop the lengthwise hexagonal tube structures.

The upper platform of a dual anchor climbing tree stand is positioned above the lower platform. The dual anchor climbing tree stand provides the ability for the user to safely and easily adjust both platforms as they are moving up or down the tree. This provides significantly improved safety and stability while ascending or descending from the tree.

In one embodiment, the seat is a mesh type, weather resistant material that provides maximum flexibility and adjustability. In one embodiment, the mesh seat is a nylon type material. A strap extends outward from each corner at each end of the adjustable and removable seat. A nylon type mesh material provides for a strong and stretchable fabric that is difficult to rip or tear.

Each strap extends to wrap around the hexagon shaped frame piece of the upper platform to wrap around the hexagon shaped frame piece and extends back upon itself for securing the strap with a buckle. The buckle provides for maximum adjustability of the seat to raise or lower the seat, or even remove the seat, as desired during use.

The upper platform and the lower platform each include a triangle cable assembly for securing each platform of the climbing tree stand to a tree. The triangle cable assembly provides for improved stability of the climbing tree stand during climbing of a tree, during descent from the tree, and while at rest in a fixed position on the tree.

The triangle cable assembly includes a combination flat steel band and steel cable wrapped or assembled together to form a triangular shaped cable that extends from each hexagon shaped frame piece at the base of the upper platform and at the base of the lower platform. The flat steel band portion of the triangle cable assembly is oriented outward from the tree and the inner point of the triangle cable assembly is oriented toward the tree to provide improved stability.

Once secured into position, the inner point of the triangle cable assembly provides for improved gripping and grips the tree more securely. Once tightened into position, the triangle cable assembly provides a more stationary and stable resting position for the climbing tree stand.

Additionally, a two platform climbing tree stand is lightweight and provides compact folding capability for ease of transport.

The upper platform includes a lumbar back support attached to the frame for providing support to the user's back.

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

The above-mentioned features will become more clearly understood from the following detailed description read together with the drawings in which:

FIG. 1-A is a perspective view illustrating a dual platform, dual anchor climbing tree stand;

FIG. 1-B is a perspective view illustrating an alternate embodiment of a dual platform, dual anchor climbing tree stand;

FIG. 2 is a perspective view of the dual platform, dual anchor climbing tree stand of FIG. 1-B attached to a tree;

FIG. 3 is a perspective view illustrating a person seated in the dual platform, dual anchor climbing tree stand of FIG. 1-B when attached to a tree;

FIG. 4 is a perspective view illustrating an upper platform of a dual platform, dual anchor climbing tree stand as in FIG. 1-A and FIG. 1-B;

FIG. 5 is a perspective view illustrating the frame for the upper platform of the dual platform, dual anchor climbing tree stand;

FIG. 6-A is a perspective view illustrating the lower platform of the dual platform, dual anchor climbing tree stand;

FIG. 6-B is a perspective view illustrating an alternative lower platform of the dual platform, dual anchor climbing tree stand;

FIG. 7 is a perspective view illustrating the frame for the lower platform of the dual platform, dual anchor climbing tree stand;

FIG. 8 is a perspective view illustrating the fastening end of a cable assembly of the dual platform, dual anchor climbing tree stand;

FIG. 9 is a perspective view illustrating both ends of the cable assembly of the dual platform, dual anchor climbing tree stand;

FIG. 10-A is an end view of the cable assembly for securing each platform of the dual anchor climbing tree stand to a tree;

FIG. 10-B is a cut-away view illustrating an internal portion of the cable assembly along its length;

FIG. 11 is a perspective view illustrating a cable pin for securing the cable assembly to the dual platform, dual anchor climbing tree stand;

FIG. 12 is a rear view of the upper platform of the dual platform, dual anchor climbing tree stand;

FIG. 13 is a front view of the upper platform of the dual platform, dual anchor climbing tree stand;

FIG. 14 is a top view of the upper platform of the upper platform of the dual platform, dual anchor climbing tree stand;

FIG. 15 is a bottom view of the upper platform of the upper platform of the dual platform, dual anchor climbing tree stand;

FIG. 16 is a right side view of the upper platform of the dual platform, dual anchor climbing tree stand;

FIG. 17 is a left side view of the upper platform of the dual platform, dual anchor climbing tree stand;

FIG. 18 is a rear view of the lower platform of the dual platform, dual anchor climbing tree stand;

FIG. 19 is a front view of the lower platform of the dual platform, dual anchor climbing tree stand;

FIG. 20 is a top view of the lower platform of the dual platform, dual anchor climbing tree stand;

FIG. 21 is a bottom view of the lower platform of the dual platform, dual anchor climbing tree stand;

FIG. 22 is a right side view of the lower platform of the dual platform, dual anchor climbing tree stand; and

FIG. 23 is a left side view of the lower platform of the dual platform, dual anchor climbing tree stand.

### DETAILED DESCRIPTION

A dual platform dual anchor climbing tree stand includes a first platform and a second platform, each platform including a frame section with a hexagonal tube structure and dual anchors, the dual anchors providing a plurality of contact points for securing the climbing tree stand, the first platform further including an adjustable seat and lumbar back support, the second platform further including foot straps, and both platforms including a cable assembly for attaching each platform to a tree.

A dual platform dual anchor climbing tree stand includes a first platform further including a plurality of hexagonal shaped tubes interconnected to form a first frame, the first frame further including a first dual anchor, the first dual anchor including a plurality of rows of teeth, each row of teeth extending rearward from the first frame in a different direction, an adjustable seat attached to the first frame, a lumbar back support attached to the first frame, a first cable assembly attachable to the first frame for securing the first platform to a tree, a second platform having a second frame section, the second frame section further including a second frame section having a second hexagon profile, the hexagon profile having a plurality of hexagonal shaped tubes interconnected to form the second frame, a first cable assembly attachable to the first frame for securing the first platform to a tree, whereby first platform and the second platform are operable together for climbing a tree and securing the first platform to the tree, and securing the second platform separately to the tree.

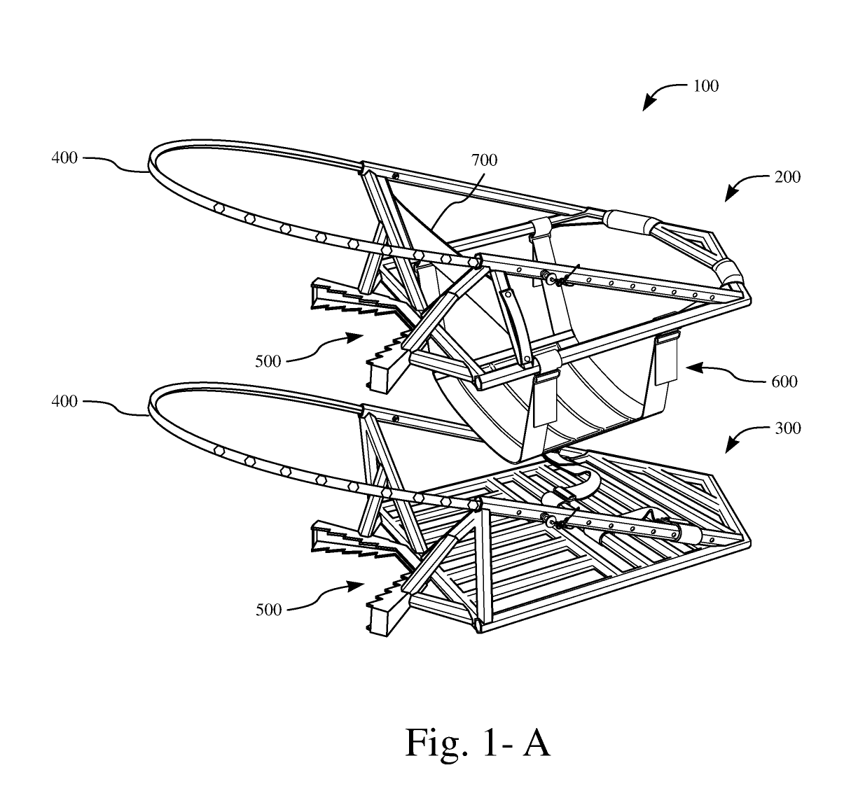

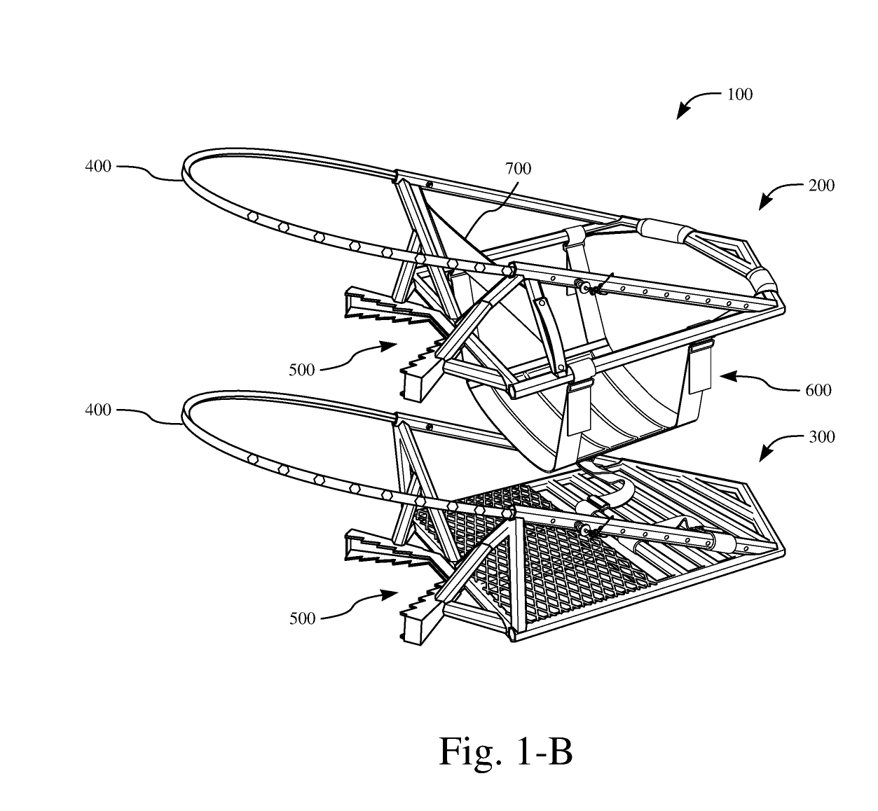

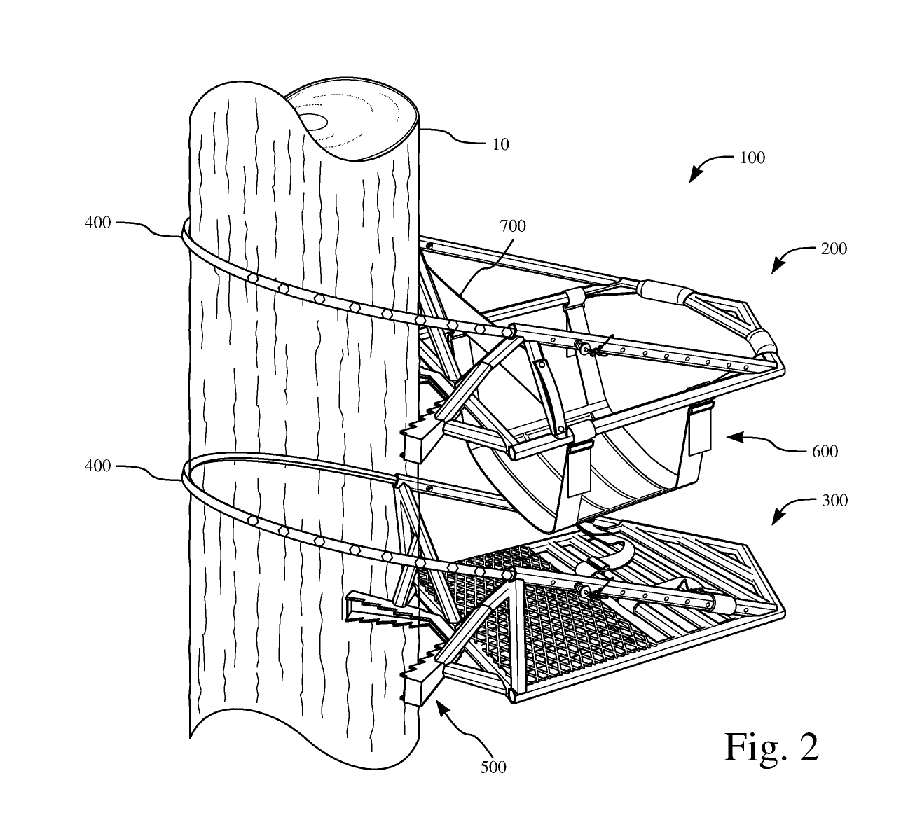

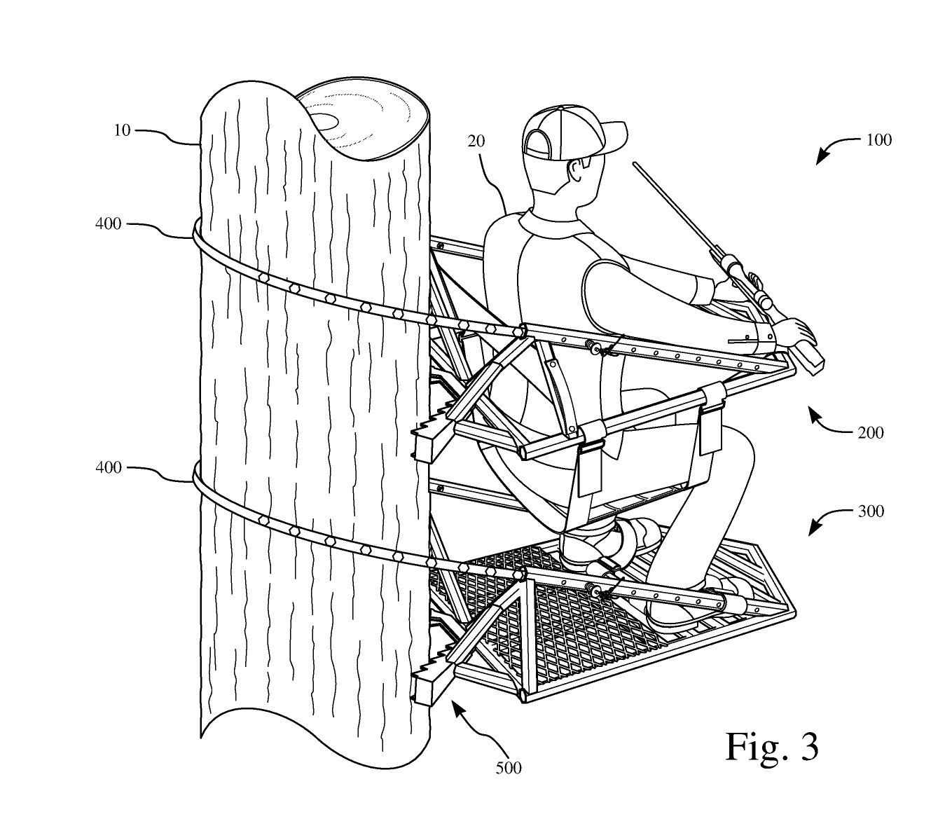

FIG. 1-A is a perspective view illustrating an embodiment of a dual platform, dual anchor climbing tree stand 100. FIG. 1-B is a perspective view illustrating an alternate embodiment of a dual platform, dual anchor climbing tree stand 100. FIG. 2 is a perspective view of the dual platform, dual anchor climbing tree stand 100 attached to a tree 10. FIG. 3 is a perspective view illustrating a person 20 seated in the dual platform, dual anchor climbing tree stand 100 when attached to the tree 10. The dual anchor climbing tree stand 100 includes an upper or seat platform 200 and a lower or foot platform 300, to form dual platforms for the dual anchor climbing tree stand 100. The seat platform 200 and the foot platform 300 each include a cable assembly 400 for securing the respective platform to a tree 10.

The seat platform 200 and the foot platform 300 each include a dual anchor 500 at the rear of the respective platform. The dual anchor 500 provides for a secure grip to the tree 10 when secured via the cable assembly 400. The seat platform 200 further includes an adjustable seat 600 and a lumbar back support 700 for improved adjustability and comfort of the user.

The seat platform 200 of the dual platform, dual anchor climbing tree stand 100 is positioned above the foot platform 300. The dual platform, dual anchor climbing tree stand 100 provides for the user to safely and easily adjust both platforms as they move up or down the tree 10, resulting in significantly improved safety and stability. Since each platform is completely adjustable on its own, there is no problem adjusting the spacing for the particular user so that the seat platform 200 is the correct distance above the foot platform 300.

In one embodiment, the dual anchor climbing tree stand 100 includes a hexagon based architecture (“hexagon profile”) for an aluminum design frame that provides maximum strength to weight ratio. The hexagon profile provides increased strength and durability. Another embodiment includes an aluminum-alloy design frame. Still another embodiment includes a titanium design frame. Many tree stands on the market use square or round tubing for the frame. The natural strength of the honeycomb structure is incorporated via the hexagonal profile of the frame.

The dual anchor 500 on each platform, the seat platform 200 and the foot platform 300, provides four points of contact rather than the traditional two, thus providing a 100% increase in surface contact. Together with the improved cable assembly 400, each dual anchor provides increased contact with and improved grip to the tree 10. The increased contact points provide for reduced likelihood of the dual anchor climbing tree stand 100 moving when the user moves. The likelihood of the dual anchor climbing tree stand 100 pivoting when the user leans out or steps out the side of the stand is greatly reduced.

Additionally, the aluminum design frame is very lightweight currently weighing in at a mere 20 or 21 pounds depending on add-on options. This lightweight design is provided in a larger than standard size also. Industry standard dual platform tree stands are around 21×34 inches with seats approximately 18×14 inches. The dual platform, dual anchor climbing tree stand 100 measures 24×36 inches in a typical configuration and includes a 21×14 inch seat. The dual anchor climbing tree stand 100 provides plenty of room to move, to be quiet, to be comfortable, and most of all to be safe. In one embodiment, the two platform climbing tree stand utilizing the hexagon profile aluminum frame is tested and certified to 350 pounds.

Being lightweight, the dual platform, dual anchor climbing tree stand 100 provides compact folding capability for ease of transport. The dual anchor climbing tree stand 100 includes an upper or seat platform 200 and a lower or foot platform 300, and each incorporates a hexagon profile aluminum design to provide maximum strength to weight ratio.

In one embodiment, the dual platform, dual anchor climbing tree stand 100 provides for the user to safely and easily adjust both platforms as they are moving up or down the tree. This provides significantly improved safety while climbing or exiting the tree.

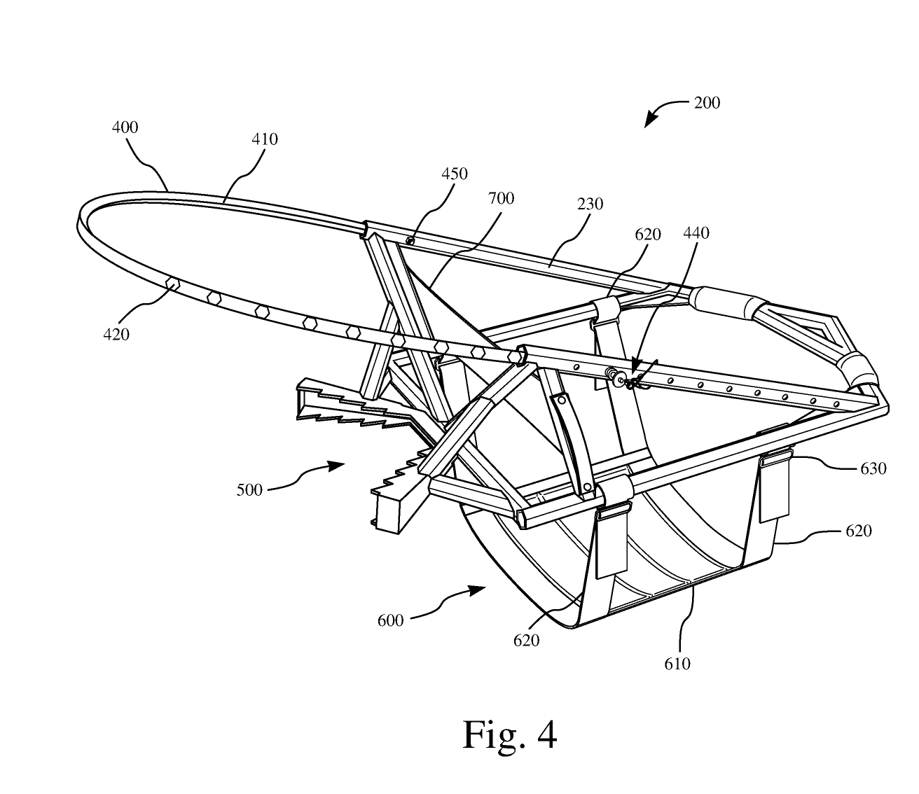

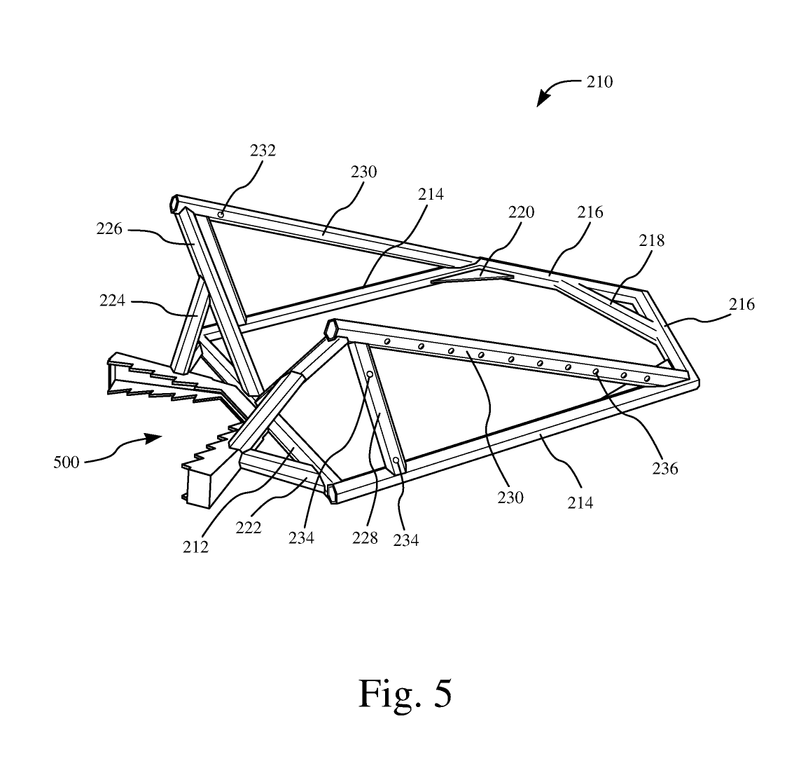

FIG. 4 is a perspective view illustrating the upper or seat platform 200 of the dual platform, dual anchor climbing tree stand 100. FIG. 5 is a perspective view illustrating the seat frame 210 for the seat platform 200 of the dual platform, dual anchor climbing tree stand 100. The upper platform or seat platform 200 includes a seat frame 210, a cable assembly 400, an adjustable seat 600, and a lumbar back support 700.

In one embodiment, the cable assembly 400 includes a flat steel band and a steel cable wrapped or assembled together to form a cable that is triangular along its length. The triangular cable assembly 400 is discussed in further detail below.

The seat platform 200 includes an adjustable seat 600 and a lumbar back support 700. In the illustrated embodiment, the adjustable seat 600 includes a mesh seat 610, four seat straps 620 connected to the seat 610 that are secured to the frame of the seat platform 200 via slide buckles 630 that provides for maximum adjustability. Additionally, the buckle 630 provides for sliding the adjustable seat out of the way during standing or climbing, and also for complete removal or replacement of the adjustable seat 600. The adjustable seat 600 is discussed in further detail below.

In the illustrated embodiment, the lumbar back support 700 is a polyester mesh material that provides back support via attachment to the seat platform 200. The lumbar back support 700 is attached at each end to a generally upright seat back brace 228 of the seat frame 210. The lumbar back support 700 is discussed in further detail below.

The seat platform 200 includes a seat frame 210 to which both the adjustable seat 600 and the lumbar back support 700 are attached. The seat platform 200 also includes a dual anchor 500 that is welded to the rear of the seat frame 210.

The seat frame 210 includes a hexagon profile aluminum design frame that provides maximum strength to weight ratio. The hexagon profile structure (herein also referred to as “hex tube”) provides increased strength and durability. The base of the seat frame 210 includes a seat rear base 212 hex tube across the rear to which several frame pieces attach. The seat rear base 212 hex tube along with the remainder of the frame excepting the dual anchor 500, are hexagon profile tubes along their length. The hexagon shape of the tubes provides for increased strength and durability of the seat frame 210.

Two seat side base 214 hex tubes extend forward from the seat rear base 212 hex tube to form the side dimensions of the seat frame 210. Each seat side base 214 hex tube extends forward to a respective seat front base 216 hex tube. The seat front base 216 hex tubes continue at an angle toward each other in a point distal from the rear of the seat frame 210. Additional support is provided via a seat cross brace 218 hex tube extending between midpoints of the seat front base 216 hex tubes along their respective length. Additional support of the intersection between each seat side base 214 hex tube and the respective seat front base 216 hex tube, is provided via substantially flat seat front braces 220, which are flat triangular portions extending from the intersection along the length of each, that is the respective seat side base 214 hex tube and the adjoining seat front base 216 hex tube.

In the upright configuration, a seat side brace 230 extends rearward and upward from the seat side base 214 hex tube-seat front base 216 hex tube intersection. The seat side brace 230 hex tube intersects near the rear of the seat frame 210 with a seat rear brace 226 hex tube and a seat back brace 228 hex tube. The seat rear brace 226 hex tube extends upward from near or at the midpoint of the seat rear base 212 hex tube. Together the seat rear brace 226 hex tube and the seat back brace 228 hex tube provide stability for the seat side brace 230 hex tube. One of the seat side brace 230 hex tubes includes a single cable fastener opening 232 for securing the non-adjustable end of the cable assembly 400 to the seat frame 210, and thus to the seat platform 210. The opposing seat side brace 230 hex tube includes a number of cable adjustment openings 236. One of the cable adjustment openings 236 is utilized for securing the adjustable end of the cable assembly 400 in place during climbing and also while the dual anchor climbing tree stand 100 is secured to the tree 10.

The dual anchor 500 is attached horizontally (in the standard or upright configuration) to the seat rear base 212 hex tube. The dual anchor 500 is braced by a seat anchor brace 222 hex tube and a seat angle brace 224 hex tube. One seat anchor brace 222 hex tube extends horizontally between the back of the respective teeth portion of the dual anchor 500 toward the rear corner of the seat frame 210 near the end of the seat rear base 212 hex tube. One seat angle brace 224 hex tube extends angularly upward between the upper back of the respective teeth portion of the dual anchor 500 toward the midpoint of the respective seat rear brace 226 hex tube. Together the seat anchor brace 222 hex tube and the seat angle brace 224 hex tube provide strength and stability while attaching the dual anchor to the seat frame 210 via at least five separate points.

The dual anchor 500 extends horizontally rearward from the rear portion of the seat frame 210. The dual anchor 500 includes two pair of teeth portions extending angularly away from the rear of the seat frame 210. In the illustrated embodiment each pair of teeth includes two rows of five teeth each. Of course, the actual number of teeth can be increased or decrease according to, for example the size of trees to be ascended. In the illustrated embodiment, each row of teeth for each teeth portion extend further from each other as the distance from the seat rear base 212 hex tube increases. In one embodiment, the teeth portion extends away from the seat rear base 212 hex tube at any angle of approximately 60 degrees. Of course, the actual angle can vary from this amount according to the target trees intended for climbing.

In the illustrated embodiment, the teeth for each portion spread to approximately two inches apart at the furthest point from the seat rear base 212 hex tube at the rear of the seat platform.

In the illustrated embodiment, each hex tube of the seat frame 210 is coated with truck bed liner type non-skid coating. In addition to the strength of the design, the non-skid coating provides for easier and more certain grip when carrying or moving the dual anchor, dual platform climbing tree stand 100. The protective coating also provides additional protection and durability to the dual platform climbing tree stand 100.

In the illustrated embodiment, the dual anchor provides a cross-teeth pattern, that is each respective row of teeth extends away from and opposite a corresponding row of teeth around the tree. By extending respective rows away from each other in a crossing pattern, the number of contact points for the respective teeth are increased. Thus each of the four rows of teeth have contact with the tree 10 when secured via the cable assembly 400.

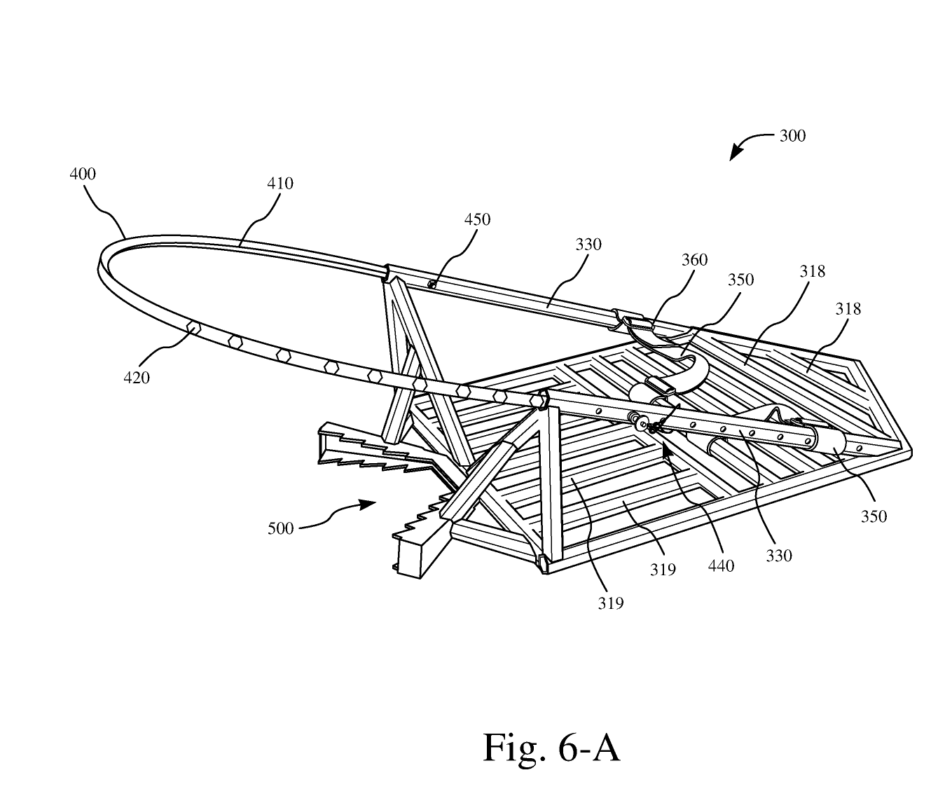

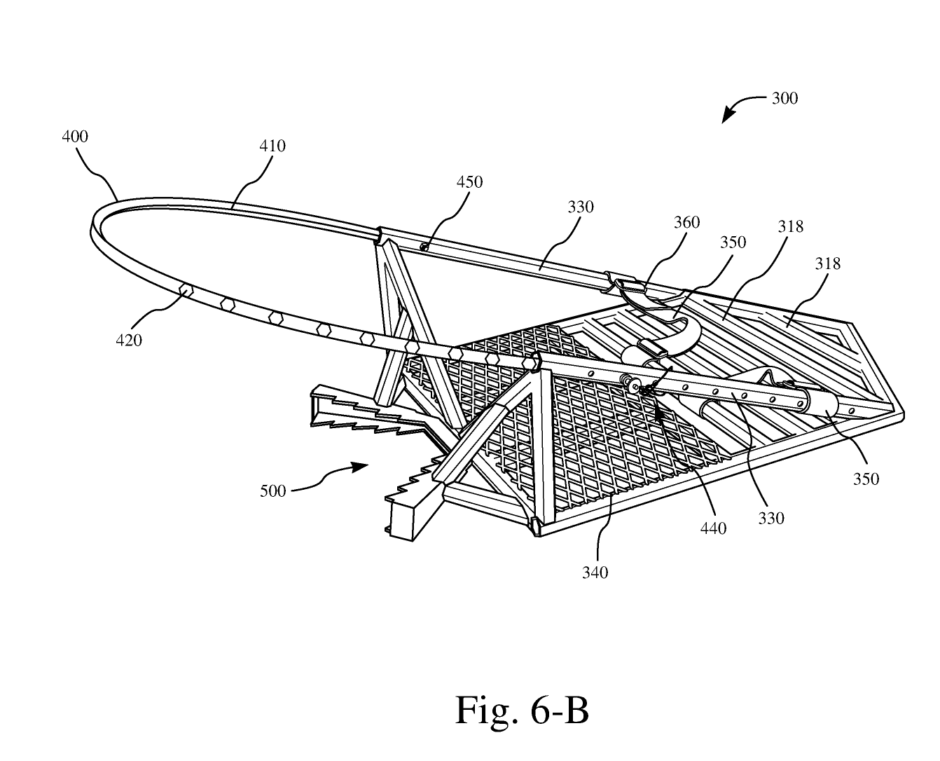

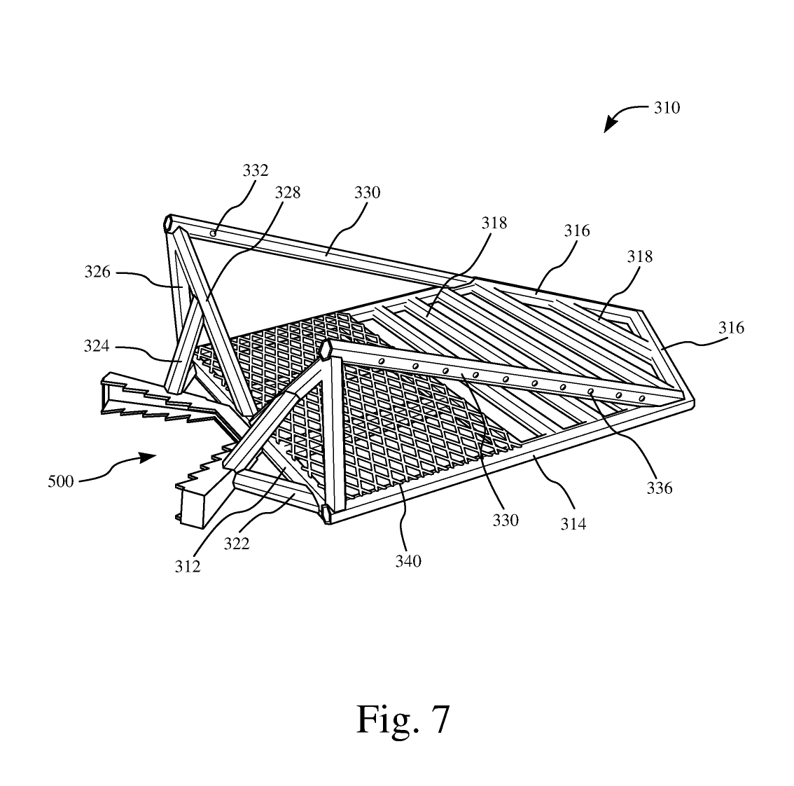

FIG. 6-A is a perspective view illustrating the lower platform or foot platform 300 of the dual platform, dual anchor climbing tree stand 100. FIG. 6-B is a perspective view illustrating an alternative foot platform 300 of the dual platform, dual anchor climbing tree stand. FIG. 7 is a perspective view illustrating the foot frame 310 for the lower platform of the dual platform, dual anchor climbing tree stand 100. In the illustrated embodiment, the foot platform includes foot cross brace 318 hex tubes, and foot length brace 319 hex tubes for provision of firm footing, and a pair of foot straps 350 for securely lifting or lowering the foot platform 300 during climbing and/or descending a tree 10. In another embodiment, the foot platform 300 further includes foot cross brace 318 hex tubes and a crosshatch grid 340 for provision of firm footing, and a pair of foot straps 350 for securely lifting or lowering the foot platform 300 during climbing and/or descending a tree 10.

The foot frame 310 includes a hexagon profile aluminum design frame that provides maximum strength to weight ratio. The hexagon profile structure (herein also referred to as “hex tube”) provides increased strength and durability. The base of the foot frame 310 includes a foot rear base 312 hex tube across the rear to which several frame pieces attach. The foot rear base 312 hex tube along with the remainder of the frame excepting the dual anchor 500, are hexagon profile tubes along their length. The hexagon shape of the tubes provides for increased strength and durability of the foot frame 310.

Two foot side base 314 hex tubes extend forward from the foot rear base 312 hex tube to form the side dimensions of the foot frame 310. Each foot side base 314 hex tube extends forward to a respective foot front base 316 hex tube. The foot front base 316 hex tubes continue at an angle toward each other in a point distal from the rear of the foot frame 310. Additional support is provided via a front cross brace 318 hex tubes extending between midpoints of the foot front base 316 hex tubes along their respective length. Additional support is provided via additional front cross brace 318 hex tubes extending between the opposing foot side base 314 hex tubes.

In the upright configuration, a foot side brace 330 extends rearward and upward from the foot side base 314 hex tube-foot front base 316 hex tube intersection. The foot side brace 330 hex tube intersects near the rear of the foot frame 310 with a foot rear angle brace 328 hex tube and a foot rear brace 326 hex tube. The foot rear angle brace 328 hex tube extends upward from near or at the midpoint of the foot rear base 312 hex tube. Together the foot rear angle brace 328 hex tube and the foot rear brace 326 hex tube provide stability for the foot side brace 330 hex tube. One of the foot side brace 330 hex tubes includes a single cable fastener opening 332 for securing the non-adjustable end of the cable assembly 400 to the foot frame 310, and thus to the foot platform 310. The opposing foot side brace 330 hex tube includes a number of cable adjustment openings 336. One of the cable adjustment openings 336 is utilized for securing the adjustable end of the cable assembly 400 in place during climbing and also while the dual anchor climbing tree stand 100 is secured to the tree 10.

The dual anchor 500 is attached horizontally (in the standard or upright configuration) to the foot rear base 312 hex tube. The dual anchor 500 is braced by a foot anchor brace 322 hex tube and a foot angle brace 324 hex tube. One foot anchor brace 322 hex tube extends horizontally between the back of the respective teeth portion of the dual anchor 500 toward the rear corner of the foot frame 310 near the end of the foot rear base 312 hex tube. One foot angle brace 324 hex tube extends angularly upward between the upper back of the respective teeth portion of the dual anchor 500 toward the midpoint of the respective foot rear angle brace 328 hex tube. Together the foot anchor brace 322 hex tube and the foot angle brace 324 hex tube provide strength and stability while attaching the dual anchor to the foot frame 310 via at least five separate points.

The dual anchor 500 extends horizontally rearward from the rear portion of the foot frame 310. The dual anchor 500 includes two pair of teeth portions extending angularly away from the rear of the foot frame 310. In the illustrated embodiment each pair of teeth includes two rows of five teeth each. Of course, the actual number of teeth can be increased or decrease according to, for example the size of trees to be ascended. In the illustrated embodiment, each row of teeth for each teeth portion extend further from each other as the distance from the foot rear base 312 hex tube increases. In one embodiment, the teeth portion extends away from the foot rear base 312 hex tube at any angle of approximately 60 degrees. Of course, the actual angle can vary from this amount according to the target trees intended for climbing.

In the illustrated embodiment, the teeth for each portion spread to approximately two inches apart at the furthest point from the foot rear base 312 hex tube at the rear of the seat platform.

In the illustrated embodiment, each hex tube of the foot frame 310 is coated with truck bed liner type non-skid coating. In addition to the strength of the design, the non-skid coating provides for easier and more certain grip when carrying or moving the dual anchor, dual platform climbing tree stand 100. The protective coating also provides additional protection and durability to the dual platform climbing tree stand 100.

In the illustrated embodiment, the dual anchor provides a cross-teeth pattern, that is each respective row of teeth extends away from and opposite a corresponding row of teeth around the tree. By extending respective rows away from each other in a crossing pattern, the number of contact points for the respective teeth are increased. Thus each of the four rows of teeth have contact with the tree 10 when secured via the cable assembly 400.

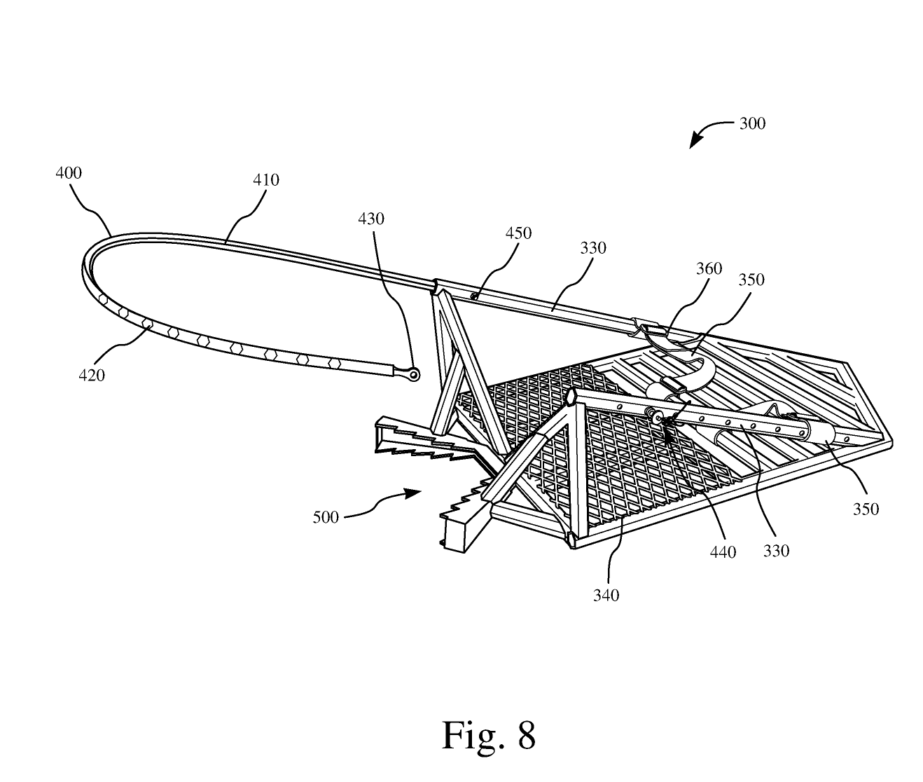

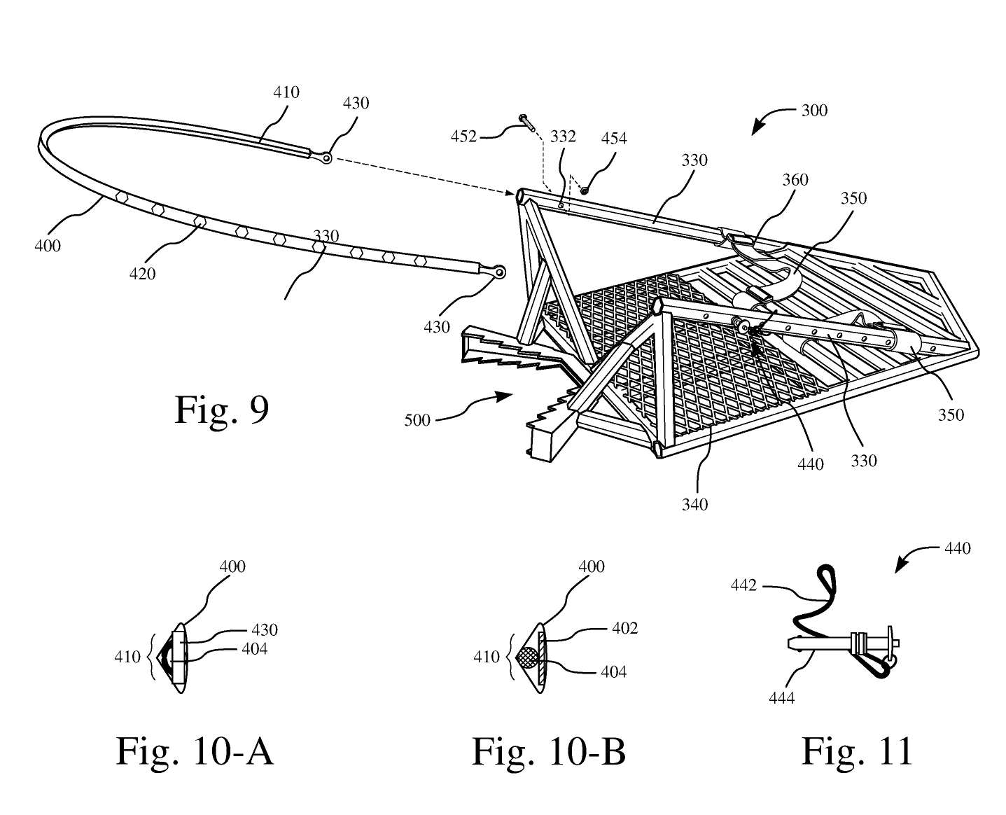

FIG. 8 is a perspective view illustrating the fastening end of a cable assembly 400 for the dual platform, dual anchor climbing tree stand 100. FIG. 9 is a perspective view illustrating both ends of the cable assembly 400 of the dual platform, dual anchor climbing tree stand 100. In the illustrated embodiment, the cable assembly 400 includes a flat steel band and a steel cable wrapped or assembled together to form a cable assembly 400 that is triangular along its length. Specifically, the triangular shape forms an inner point 410 along the inner length of the cable assembly 400.

The cable assembly 400 includes flat eye hooks 430 at either end for securing the dual anchor, dual platform climbing tree stand 100 to a tree 10. In the illustrated embodiment, one end of the cable assembly 400 is attached via a flat eye hook 430 within one of the foot side braces 330 of the foot platform 300. A nut-and-bolt 450 combination secure the flat eye hook 430 within the foot side brace 330. In the seat platform 200, a nut-and-bolt 450 combination secure the flat eye hook 430 within the seat side brace 230.

Specifically, a bolt 452 extends through the cable fastener opening 332, through the flat eye hook 430, and is secured via a nut 452 to the foot side brace 330 of the foot platform 300. Similarly, for the seat platform 200, though not shown, a bolt 452 extends through the cable fastener opening 232, through the flat eye hook 430, and is secured via a nut 452 to the seat side brace 230 of the seat platform 200.

The cable assembly 400 includes hex shaped reflective markers 420 along the flat side of the cable assembly 400. The reflective markers 420 and the flat eye hook 430 are spaced so that they correspond together to the spacing of the cable adjustment openings 236 of the seat platform 200, or the cable adjustment openings 336 of the foot platform 300. Regardless of the cable adjustment opening 236 or 336 desired, the reflective markers 420 show through as an indicator that the flat eye hook 430 is lined up with the respective cable adjustment opening 236 or 336.

The cable assembly 400 is attached within the foot side brace 330 of the foot platform 300 via the nut and-bolt 450 combination, and extends around the tree 10 and into the opposite foot side brace 330 for attachment via a spring loaded cable pin 440 within the desired cable adjustment opening 336. For the seat platform 200, the cable assembly 400 is attached within the seat side brace 230 via the nut and-bolt 450 combination and extends around the tree 10 and into the opposing seat side brace 230 for attachment via a spring loaded cable pin 440 within the desired cable adjustment opening 236.

When both cable assemblies 400 are secured, the seat platform 200 and the foot platform 300 of the dual anchor, dual platform climbing tree stand 100 are positioned with the seat platform 200 directly above the foot platform 300. Since each platform is completely adjustable on its own, there is no problem adjusting the spacing for the particular user so that the seat platform 200 is the correct distance above the foot platform 300. The dual anchor, dual platform climbing tree stand 100 provides for the user to safely and easily adjust both platforms as they move up or down the tree 10, resulting in significantly improved safety and stability.

The seat platform 200 and the foot platform 300 of the dual anchor, dual platform climbing tree stand 100, each include a triangular cable assembly 400 for securing each to a tree 10. The triangular cable assembly 400 provides for improved stability of the dual anchor, dual platform climbing tree stand 100 during the climbing of the tree 10, during descent from the tree 10, and while at rest in a fixed position on the tree 10.

FIG. 10-A is an end view of the cable assembly 400 for securing each platform of the dual anchor climbing tree stand 100 to a tree 10. FIG. 10-B is a cut-away illustrating an internal view of the cable assembly 400 along its length. In the illustrated embodiment, the cable assembly 400 includes a flat steel band 402 and a steel cable 404 wrapped or assembled together to form a cable assembly 400 that is triangular along its length.

The cable assembly 400 includes a flat steel band 402, a steel cable 404, and an eye hook 430. A flat eye hook 430 is secured to each end of the steel cable 404 and extends into each hexagon frame tube section, either the seat side brace 230 of the seat platform 200, or the foot side brace 330 of the foot platform 300.

Each flat eye hook 430 is secured in place via a cable pin 440 extending through the respective cable adjustment openings 236 or 336 of the respective platform. In a typical configuration, the connection point of the flat eye hook 430 is adjustable within the seat side brace 230, or the foot side brace 330, of the respective platform.

In other embodiments, various type pin fastening mechanisms may be used for securing the flat eye hook 430 in place within the respective hexagon frame tube section and are considered to be within the scope of this disclosure.

The flat steel band 402 and the steel cable 404 are wrapped together to form a cable assembly 400 that is triangular along its length. The flat steel band 402 and the steel cable 404 are wrapped in a way that a triangular point 410 is formed along the length of the cable assembly 400.

In one embodiment, the flat steel band 402 is ⅝ inches wide and the steel cable 404 is ¼ inch diameter. In some embodiments, other dimensions for the steel band 402 and/or the steel cable 404 are chosen according to appropriate strength and flexibility concerns of the dual anchor, dual platform climbing tree stand 100.

In use the flat steel band 402 portion of the cable assembly 400 is oriented outward from the tree 10, and inner point 410 length of the cable assembly 400 is oriented toward the tree 10. With the inner point 410 of the cable assembly 400 oriented toward the tree, improved stability is provided. The inner point length 410 of the cable assembly 400 reduces or eliminates snag against the tree bark during climbing or descent from the tree 10 while using the dual anchor, dual platform climbing tree stand 100. The cable assembly 400 provides ease of movement via rolling off the bark rather than digging in during use, whether climbing or descending from the tree 10. The triangular shape of the cable assembly 400 glides more smoothly along the surface of a tree 10. The improved movement reduces sudden stops starts, and unexpected jerking during ascent or descent from the desired level for the dual anchor, dual platform climbing tree stand 100. Rather than digging into the tree 10, the triangular cable assembly 400 provides for smoother movement and improved safety of the user during movement.

The flat eye hook 430 is attached at each end of the cable assembly 400 at an appropriate angle so that the flat eye hook 430 fits correctly into either the seat side brace 230 of the seat platform 200, or the foot side brace 330 of the foot platform 300 for orientation with the respective cable adjustment openings 236 or 336 of the respective platform. Additionally, the flat eye hook 430 is oriented so that the flat steel band 402 of the cable assembly 400 is oriented parallel to and outward from the tree 10. In this way the inner point 410 of the triangular cable assembly 400 provides maximum gripping capability when secured to the tree 10.

It should also be noted that other type fasteners may be attached to the steel cable 404 of the triangular cable assembly for securing to the seat side brace 230 of the seat platform 200, or the foot side brace 330 of the foot platform 300, so long as the orientation of a loop or hook within the fastener is such that cable assembly 400 is securable via extending pins or such like through the seat side brace 230 or through the foot side brace 330, and further so that the cable assembly 400 is oriented with the flat steel band 402 substantially parallel with and away from the tree 10 and with the inner point length 410 of the cable assembly 400 oriented toward the tree 10.

Once secured into position, the inner point length 410 of the triangular cable assembly 400 provides for improved gripping and so grips the tree more securely. Once tightened into position, the triangular cable assembly 400 provides a more stationary and stable resting position for the dual anchor, dual platform climbing tree stand 100.

FIG. 11 is a perspective view illustrating one exemplary embodiment of a spring loaded cable pin assembly 440 for securing the cable assembly 400 to the dual platform, dual anchor climbing tree stand 100. The spring loaded cable pin assembly 440 includes a spring loaded cable pin 442 and a loop 444 for attaching the cable pin assembly 440 to a seat side brace 230 of the seat platform 200, or a foot side brace 330 of the foot platform 300. The loop 444 is attached at one end to the spring loaded cable pin 440 and is free at the other end. By inserting the spring loaded cable pin 442 through the free end of the loop 444, the cable pin assembly 440 remains attached to the respective seat platform even if dropped by the user. The risk of dropping the spring loaded cable pin 440 from high in a tree is greatly reduced and safety is increased.

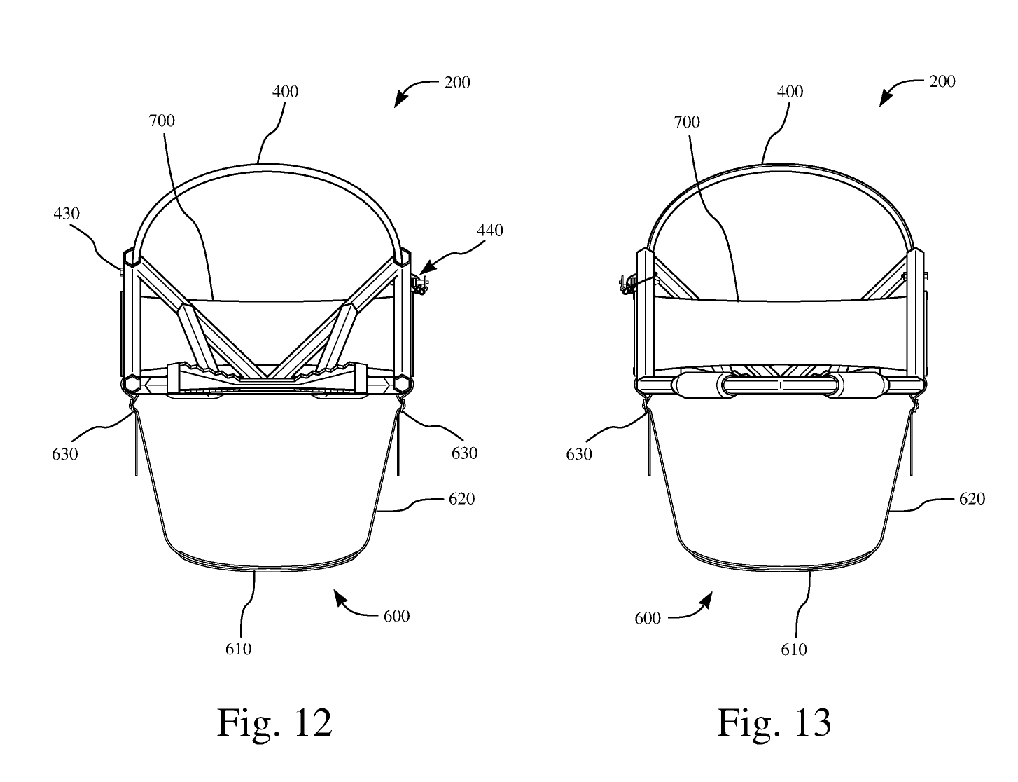

FIG. 12 is a rear view of the seat platform 200 of the dual platform, dual anchor climbing tree stand 100, and FIG. 13 is a front view of the seat platform 200 of the dual platform, dual anchor climbing tree stand 100.

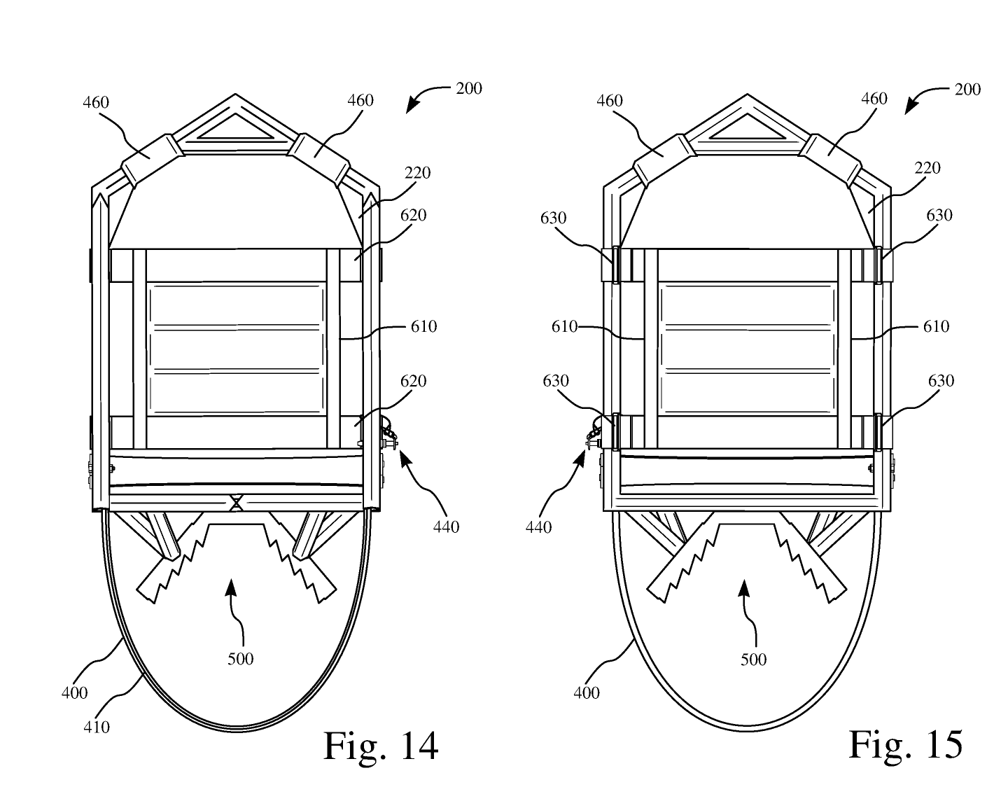

FIG. 14 is a top view of the seat platform 200 of the dual platform, dual anchor climbing tree stand 100, and FIG. 15 is a bottom view of the seat platform 200 of the upper platform of the dual platform, dual anchor climbing tree stand 100.

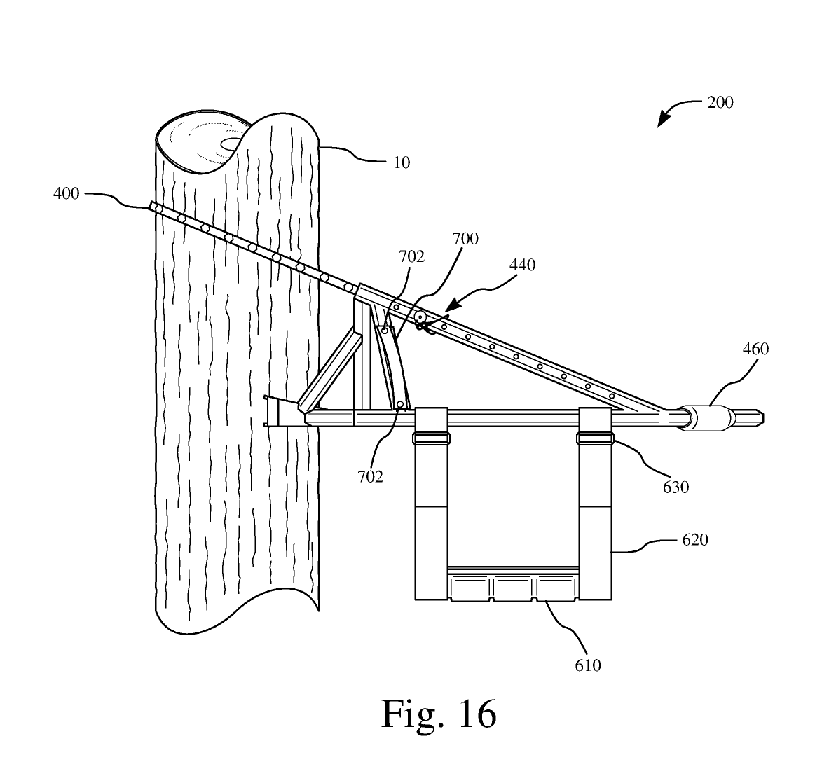

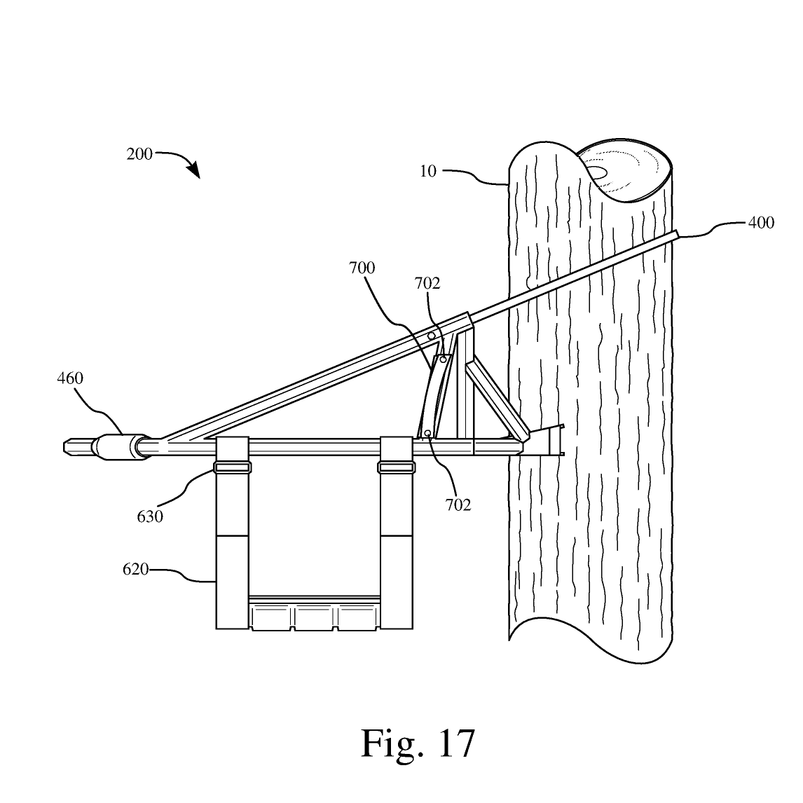

FIG. 16 is a right side view of the seat platform 200 of the dual platform, dual anchor climbing tree stand 100, and FIG. 17 is a left side view of the seat platform 200 of the dual platform, dual anchor climbing tree stand 100.

The seat platform 200 of the dual anchor climbing tree stand 100 includes an adjustable seat 600 and a lumbar back support 700. In the illustrated embodiment, the adjustable seat 600 includes a mesh seat 610, four seat straps 620 connected to the seat 610 that are secured to the frame of the seat platform 200 via slide buckles 630 that provides for maximum adjustability. Additionally, the buckle 630 provides for sliding the adjustable seat out of the way during standing or climbing, and also for complete removal or replacement of the adjustable seat 600.

In the illustrated embodiment, the adjustable seat 600 is a mesh type seat, weather resistant material that provides maximum flexibility and adjustability. In another embodiment, the mesh seat is a nylon type material. A seat strap 620 extends outward from the mesh seat 610 and near each end of the adjustable seat 600. A nylon type mesh material provides for a strong and stretchable fabric that is difficult to rip or tear.

Each seat strap 620 extends to wrap around a seat cross base 219 hex tube of the seat frame 210 of the seat platform 200. The seat strap 620 wraps around the hex tube and extends back upon itself for securing the strap with a slide buckle 630. It the illustrated embodiment, the slide buckle 630 is a 2-inch slide buckle. It should be appreciated that other type buckles and other size buckles may also be suitable for securing the straps in a manner to prevent unwanted movement of the adjustable seat 600.

The slide buckle 630 provides for maximum adjustability of the adjustable seat 600 to raise or lower the seat as desired during use. Additionally, the adjustable seat 600 can be completely removed if desired via simply removing the end of the strap from the slide buckle 630 until the seat is loosened from the seat cross base 219 hex tube of the seat platform 200.

It should also be noted that the seat straps 620 can be loosened so that the adjustable seat 600 can be pushed out of the way without necessarily having to remove the adjustable seat 600. Such flexibility provides for a disengagement of the adjustable seat 600 while not completely removing the adjustable seat 600 from the seat platform 200. Such capability reduces the likelihood of dropping, misplacing, or even loosing the adjustable seat 600 during use due to a temporary need to disengage the adjustable seat 600.

In the illustrated embodiment, the lumbar back support 700 is a polyester mesh material that provides back support via attachment to the seat platform 200. The lumbar back support 700 is attached at each end to a generally upright seat back brace 228 of the seat frame 210. The lumbar back support 700 is discussed in further detail below.

The seat platform 200 includes a seat frame 210 to which both the adjustable seat 600 and the lumbar back support 700 are attached. The seat platform 200 also includes a dual anchor 500 that is welded to the rear of the seat frame 210.

In one embodiment, the seat platform 200 includes a lumbar back support 700 that provides for support of the user's back without the need for leaning against a tree or a less supportive back rest. In one embodiment, the lumbar back support 700 is a polyester mesh netting material. Further the lumbar back support 700 may also be water proof. It should be noted that in various embodiments, the lumbar back support 700 is made from other materials that provide back support via attachment to the upper platform.

The lumbar back support 700 is attached at each end to a seat back brace 228 hex tube of the seat frame 210. In the illustrated embodiment, the fasteners are rivets that are attached to the seat back brace 228 hex tube through the back fastener opening 234. In other embodiments, the fasteners are snaps or any other type fastener known in the art for securing a load bearing mesh type or netting type material.

In one embodiment, the lumbar back support 700 wraps around the seat back brace 228 hex tube and is pulled taught to provide the desired back support. In some embodiments, the lumbar back support 700 is further adjustable to provide variation in back support according to user preference.

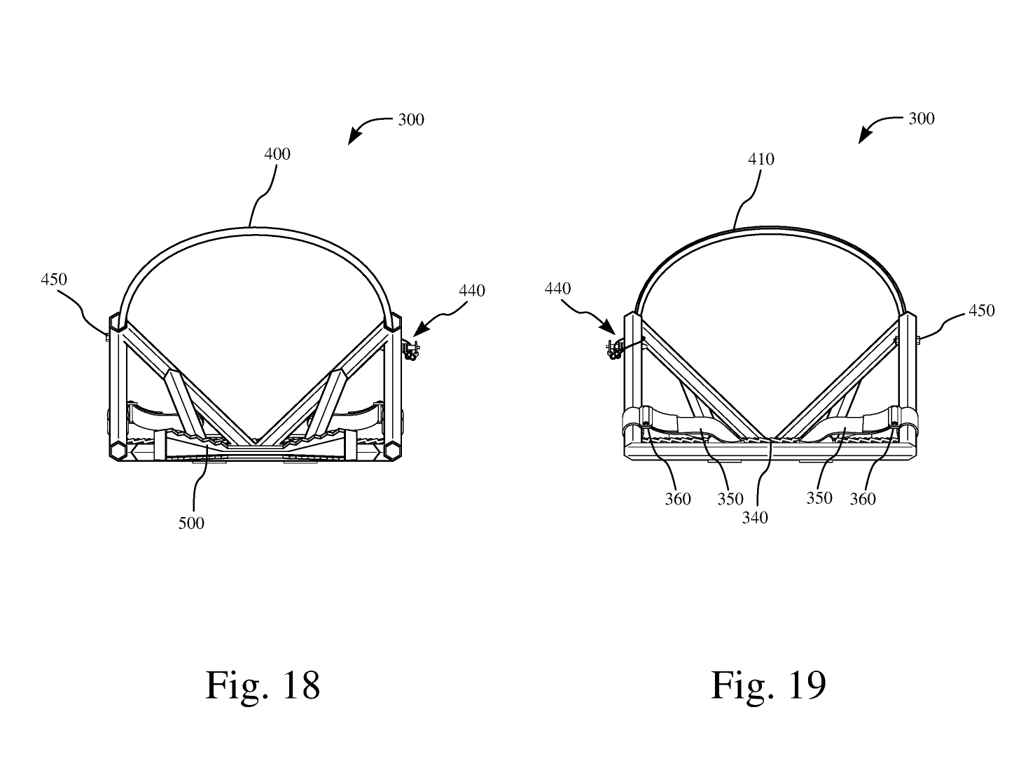

FIG. 18 is a rear view of the lower platform of the dual platform, dual anchor climbing tree stand 100, and FIG. 19 is a front view of the lower platform of the dual platform, dual anchor climbing tree stand 100

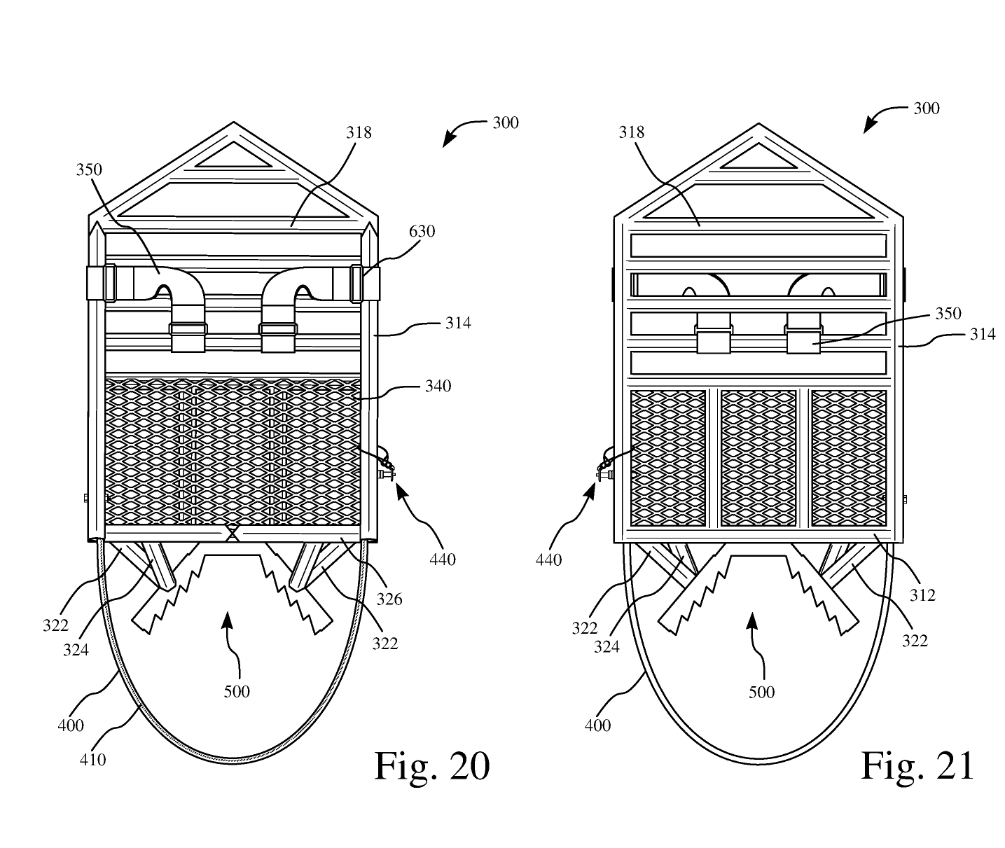

FIG. 20 is a top view of the lower platform of the dual platform, dual anchor climbing tree stand 100, and FIG. 21 is a bottom view of the lower platform of the dual platform, dual anchor climbing tree stand 100.

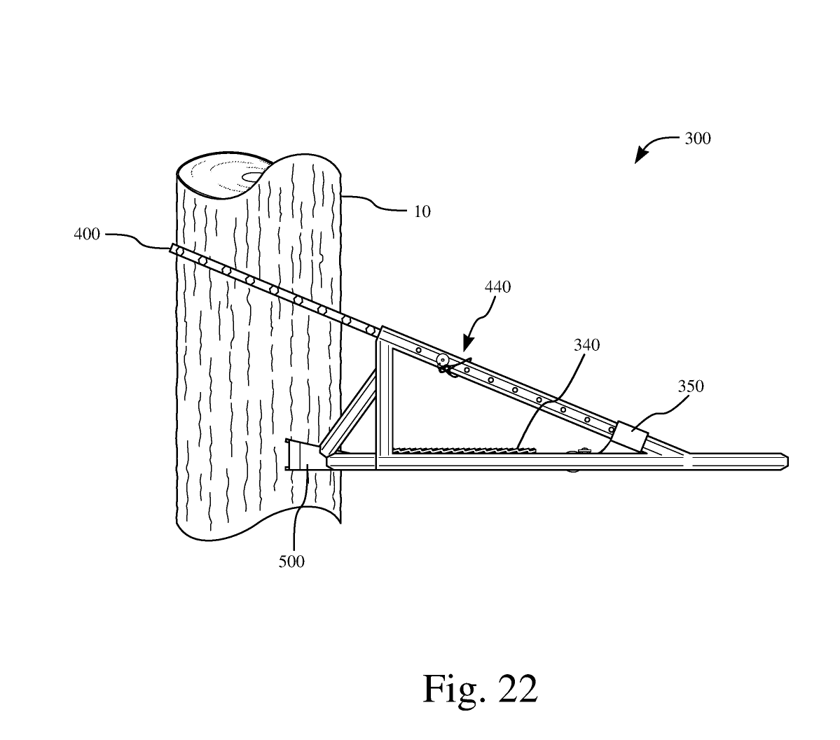

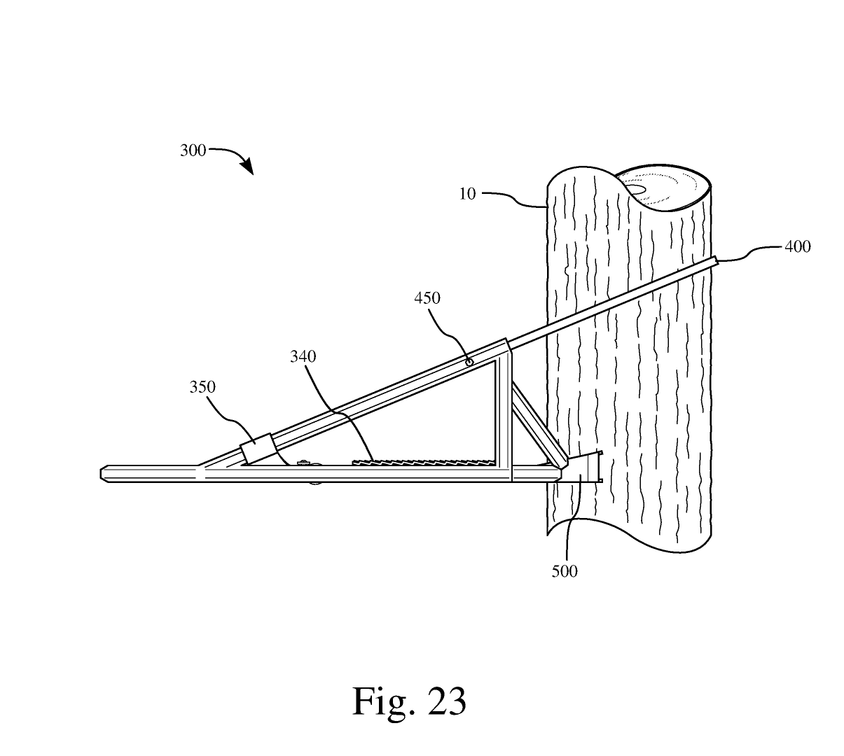

FIG. 22 is a right side view of the lower platform of the dual platform, dual anchor climbing tree stand 100, and FIG. 23 is a left side view of the lower platform of the dual platform, dual anchor climbing tree stand 100.

The foot platform 300 also includes foot straps 350 for lifting the foot platform 300 during climbing in a conventional manner.

From the foregoing description, it will be recognized by those skilled in the art that a dual platform dual anchor climbing tree stand that includes a first platform and a second platform, each platform including a frame section with a hexagonal tube structure and dual anchors, the dual anchors providing a plurality of contact points for securing the climbing tree stand, the first platform further including an adjustable seat and lumbar back support, the second platform further including foot straps, and both platforms including a cable assembly for attaching each platform to a tree has been provided.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A dual platform climbing tree stand, the dual platform climbing tree stand comprising:
a first platform further including:
a first frame section having a first hexagon profile, the hexagon profile including a plurality of hexagonal shaped tubes interconnected to form the first frame;
the first frame further including a first dual anchor, the first dual anchor including a plurality of rows of teeth, each row of teeth extending rearward from the first frame in a different direction;
an adjustable seat attached to the first frame;
a lumbar back support attached to the first frame;
a first cable assembly attachable to the first frame for securing the first platform to a tree;
a second platform having a second frame section, the second frame section further including:
a second frame section having a second hexagon profile, the hexagon profile having a plurality of hexagonal shaped tubes interconnected to form the second frame;
a first cable assembly attachable to the first frame for securing the first platform to a tree;
whereby first platform and the second platform are operable together for climbing a tree and securing the first platform to the tree, and securing the second platform separately to the tree.

2. The dual platform climbing tree stand of claim 1, further comprising each row of teeth of the first dual anchor extending rearward at an angle from a rear hexagonal tube of the first frame, and each row of teeth of the second dual anchor extending rearward at an angle from a rear hexagonal tube of the second frame.

3. The dual platform climbing tree stand of claim 2, the first dual anchor further comprising at least two pair of rows of teeth, wherein each pair of rows of teeth extend at corresponding and different directions from each other relative to the rear hexagonal tube of the first frame.

4. The dual platform climbing tree stand of claim 2, the second dual anchor further comprising at least two pair of rows of teeth, wherein each pair of rows of teeth extend at corresponding and different directions each other relative to the rear hexagonal tube of the second frame.

5. The dual platform climbing tree stand of claim 1, further comprising the first cable assembly extending from a first side hexagonal tube and removably fastenable to a second side hexagonal tube, wherein the first side hexagonal tube and the second side hexagonal tube are parallel and opposite each other extending lengthwise along the first platform.

6. The dual platform climbing tree stand of claim 1, further comprising the first frame including a plurality of crossing hexagonal tube structures extending between opposing sides of the first frame, and a plurality of lengthwise hexagonal tube structures extending from a rear hexagonal tube toward the front of the first frame section.

7. The dual platform climbing tree stand of claim 6, further comprising a grid section attached atop the lengthwise hexagonal tube structures.
